(19) United States
(12) Patent Application Publication
(10) Pub. No.: US 2024/0427976 A1
(43) Pub. Date: Dec. 26, 2024

(54) AUTOMATIC GENERATION OF MULTI-CYCLE PATH DESIGN CONSTRAINT FOR FORWARD ANNOTATION IN INTEGRATED CIRCUIT DESIGN

(71) Applicant: Synopsys, Inc., Sunnyvale, CA (US)

(72) Inventors: Satyamurthy Pullela, Marlborough, MA (US); Chirag Mehta, Bangalore (IN)

(21) Appl. No.: 18/528,420

(22) Filed: Dec. 4, 2023

(30) Foreign Application Priority Data
Jun. 23, 2023 (IN) 202341042107

(51) Int. Cl. G06F 30/337; G06F 119/12

(52) U.S. Cl. CPC G06F 30/337; G06F 2119/12

(57) ABSTRACT

A method includes: receiving an integrated circuit design; obtaining a timing path between a first sequential circuit element at a launch end of the timing path and a second sequential circuit element at a capture end of the timing path of the integrated circuit design; determining, by a processing device, a common clock that drives a first clock clocking the first sequential circuit element and a second clock clocking the second sequential circuit element based on a clock graph of relationships between a plurality of clocks of the integrated circuit design; and setting a timing constraint for the timing path of the integrated circuit design based on a period of the common clock.

### RELATED APPLICATION

This application claims priority to and the benefit of Indian Provisional Patent Application No. 202341042107 filed in the Indian Patent Office on Jun. 23, 2023, the entire disclosure of which is incorporated by reference herein.

### TECHNICAL FIELD

The present disclosure generally relates to an electronic design automation (EDA) system for designing integrated circuits. In particular, the present disclosure relates to automatic generation of a multi-cycle path design constraint for forward annotation in an integrated circuit design.

### BACKGROUND

Processes for designing integrated circuits such as central processing units (CPUs), graphics processing units (GPUs), digital signal processors (DSPs), neural network accelerators, and the like progress from higher level descriptions of the hardware (e.g., based on functionality) to more detailed descriptions of the integrated circuits (e.g., the placements of individual circuit elements and the connections therebetween). The more detailed descriptions of integrated circuits may be used to control semiconductor fabrication hardware such as photolithography, etching, deposition, and implantation machines to fabricate integrated circuits in accordance with an integrated circuit design.

The integrated circuit design process also includes verification stages that analyze whether the designed integrated circuit operates as intended, such as determining whether the additional detail generated during a stage of the design process (e.g., the placement and routing of circuit elements) satisfies various design constraints such as timing constraints. These verification stages include, for example, software simulation (e.g., using a computer program to simulate the operation of the integrated circuit design), emulation (e.g., using reconfigurable hardware such as field programmable gate arrays to implement the design and emulate the operation of the integrated circuit design), and prototyping (e.g., fabricating a real integrated circuit based on the design).

The above information disclosed in this Background section is only for enhancement of understanding of the present disclosure, and therefore it may contain information that does not form the prior art that is already known to a person of ordinary skill in the art.

### SUMMARY

According to one embodiment of the present disclosure, a method includes: receiving an integrated circuit design; obtaining a timing path between a first sequential circuit element at a launch end of the timing path and a second sequential circuit element at a capture end of the timing path of the integrated circuit design; determining, by a processing device, a common clock that drives a first clock clocking the first sequential circuit element and a second clock clocking the second sequential circuit element based on a clock graph of relationships between a plurality of clocks of the integrated circuit design; and setting a timing constraint for the timing path of the integrated circuit design based on a period of the common clock.

The timing constraint may be a maximum path delay constraint.

The timing constraint may be a multicycle path constraint.

The integrated circuit design may include a clock divider, and the plurality of clocks of the integrated circuit design may include: an input clock supplied to the clock divider; and a derived clock output by the clock divider, the derived clock having a derived clock period twice as long as an input clock period of the input clock.

The may further include constructing the clock graph, the constructing the clock graph including: adding a first root node of the clock graph corresponding to a first user clock of the plurality of clocks; tracing the first user clock to a first clock divider of the integrated circuit design; identifying a first derived clock at a first output of the first clock divider; and adding a first child node corresponding to the first derived clock as a child of the first root node in the clock graph.

The method may further include: tracing the first derived clock to a second clock divider; identifying a second derived clock at a second output of the second clock divider; and adding a second child node corresponding to the second derived clock as a child of the first child node in the clock graph.

The method may further include: adding a second root node of the clock graph corresponding to a second user clock; tracing the second user clock to a third clock divider of the integrated circuit design; identifying a third derived clock at a third output of the third clock divider; and adding a third child node corresponding to the third derived clock as a child of the second root node in the clock graph.

According to one embodiment of the present disclosure, a system includes: a memory storing instructions; and a processor, coupled with the memory and to execute the instructions, the instructions when executed cause the processor to: receive an integrated circuit design; compute a timing path between a first sequential circuit element at launch end of the timing path and a second sequential circuit element at a capture end of the timing path of the integrated circuit design; compute, using a clock graph of relationships between a plurality of clocks of the integrated circuit design, a timing constraint on the timing path based on a first clock driving the first sequential circuit element and a second clock driving the second sequential circuit element; output a machine-readable representation of the integrated circuit design, the machine-readable representation including a representation of the computed timing constraint of the timing path; and perform a stage of an electronic design automation process on the machine-readable representation of the integrated circuit design based on the representation of the computed timing constraint of the timing path.

The timing constraint may be a maximum path delay constraint.

The timing constraint may be a multicycle path constraint.

The stage of the electronic design automation process may include static timing analysis based on the computed timing constraint.

The stage of the electronic design automation process may include placement and routing of cells of the integrated circuit design based on the computed timing constraint.

The stage of the electronic design automation process may include generating a representation of the integrated circuit design to configure an emulation system including one or more field programmable gate arrays based on the computed timing constraint.

The memory may further store instructions, which when executed by the processor, cause the processor to: add a first root node of the clock graph corresponding to a first user clock; trace the first user clock to a first clock divider of the integrated circuit design; identify a first derived clock at an output of the first clock divider; and add a first child node corresponding to the first derived clock as a child of the first root node in the clock graph.

According to one embodiment of the present disclosure, a non-transitory computer-readable medium includes stored instructions, which when executed by a processor, cause the processor to: receive an integrated circuit design; obtain a timing path between a first sequential circuit element at launch end of the timing path and a second sequential circuit element at a capture end of the timing path of the integrated circuit design; determine a common clock that drives a first clock clocking the first sequential circuit element and a second clock clocking the second sequential circuit element based on a clock graph of relationships between a plurality of clocks of the integrated circuit design; set a timing constraint for the timing path of the integrated circuit design based on a period of the common clock; and output a machine-readable representation of the integrated circuit design, the machine-readable representation including a representation of the timing constraint of the timing path.

The timing constraint may be a maximum path delay constraint.

The timing constraint may be a multicycle path constraint.

The integrated circuit design may include a clock divider, and the plurality of clocks of the integrated circuit design may include: an input clock supplied to the clock divider; and a derived clock output by the clock divider, the derived clock having a derived clock period that is twice as long as an input clock period of the input clock.

The non-transitory computer-readable medium may further store instructions, which when executed by the processor, cause the processor to: add a first root node of the clock graph corresponding to a first user clock of the plurality of clocks; trace the first user clock to a first clock divider of the integrated circuit design; identify a first derived clock at a first output of the first clock divider; and add a first child node corresponding to the first derived clock as a child of the first root node in the clock graph.

The non-transitory computer-readable medium may further store instructions, which when executed by the processor, cause the processor to: trace the first derived clock to a second clock divider; identify a second derived clock at a second output of the second clock divider; and add a second child node corresponding to the second derived clock as a child of the first child node in the clock graph.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is an example of an integrated circuit design having a user clock C0 and multiple derived clocks, according to one embodiment of the present disclosure.

FIG. 2A shows a clock divider and a relationship between an input clock and an output derived clock, according to one embodiment of the present disclosure.

FIG. 2B illustrates possible derived clocks that may be output by a D flip-flop operating as a clock divider that is driven by an input clock signal at its rising edge, according to one embodiment of the present disclosure.

FIG. 3 is a flowchart illustrating a method for automatically determining timing constraints, according to one embodiment of the present disclosure.

FIG. 4A is an example of a clock graph depicting the relationships between clocks, according to one embodiment of the present disclosure.

FIG. 4B is a flowchart depicting a method for adding a node to a clock graph, according to one embodiment of the present disclosure.

FIG. 5 is a flowchart depicting a method for setting timing constraints using multicycle path constraints, according to one embodiment of the present disclosure.

FIG. 6 is a flowchart depicting a method for setting timing constraints using maximum path delay constraints, according to one embodiment of the present disclosure.

FIG. 7 depicts a flowchart of various processes used during the design and manufacture of an integrated circuit in accordance with some embodiments of the present disclosure.

FIG. 8 depicts a diagram of an example emulation system in accordance with some embodiments of the present disclosure.

FIG. 9 depicts a diagram of an example computer system in which embodiments of the present disclosure may operate.

### DETAILED DESCRIPTION

Aspects of the present disclosure relate to automatic generation of multi-cycle path design constraints for forward annotation in integrated circuit designs.

Aspects of embodiments of the present disclosure relate to methods for automatically computing clock constraints or timing constraints in an integrated circuit design. Clock signals are used in synchronous integrated circuit designs to synchronize the operation of different portions of an integrated circuit. As logic signals propagate through combinational circuit elements (e.g., Boolean logic gates such as AND, OR, and NOT gates) of an integrated circuit design, these combinational circuit elements introduce delays (e.g., a difference between a time at which a signal change arrives at an input of a circuit element and a time at which the output of the circuit element changes). In addition, wires connecting combination gates also introduce delays (e.g., the time at which an output of a circuit element changes the signal level on a wire and the time at which that change appears at the input of a fanout circuit element connected to the wire). A signal propagating through a circuit path that includes multiple combinational circuit elements connected in series therefore experiences a delay based on the individual delays of those circuit elements and the wires connecting the circuit elements. A sequential circuit element (e.g., a circuit device that stores values such as a flip-flop, a latch, a memory, or a register) can reliably store an input signal when the change in the signal value reaches at least a setup time (t_{S}) before the edge of a clock signal controlling the sequential circuit element and the signal value is held constant for at least a hold time (t_{H}) after the edge of the clock signal. One aspect of a timing constraint relates to the window of time during which a signal is expected or designed to reach a sequential circuit element, such as ensuring that the signal arrives before the setup time and is held for at least the hold time. However, a timing violation may occur, for example, when the total amount of delay introduced by the circuit path feeding an input of the sequential circuit element causes the signal to arrive after the setup time.

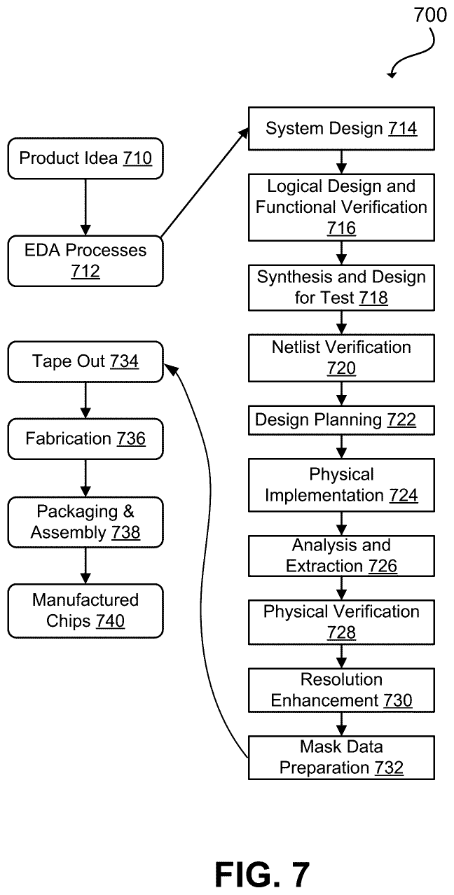

As integrated circuit designs increase in size and complexity, the timing constraints associated with clock signals within the integrated circuit designs also become more complex. For example, the integrated circuit design may include circuit elements, such as clock dividers, that generate derived clock signals in response to input clock signals, where those derived clock signals may set timing constraints on respective parts of the integrated circuit design (e.g., different sequential elements may be controlled by different clock signals). This complexity in clock signals can increase the difficulty in performing various stages of the integrated circuit design process (see, e.g., FIG. 7, below), in a manner that satisfies timing constraints as well as other design constraints. For example, synthesizing an integrated circuit design for emulation or fabrication as a prototype includes placing cells (standard circuit elements) of an integrated circuit design and routing cells (forming the electrical connections between the cells). The placement and routing step has an impact on timing—e.g., when cells are placed farther apart, the wires connecting those cells become longer, thereby increasing the delay along that path, which increases the amount of time that it takes for a signal to propagate along such a circuit path. Therefore, the process for designing an integrated circuit includes verifying the results of a given stage, such as by ensuring that the resulting placements and routing of the cells satisfies the timing constraints of the integrated circuit design.

A given stage of the integrated circuit design process may be performed multiple times (e.g., over multiple iterations) before generating a result that satisfies the design constraints. For example, an initial run of a placement and routing stage generates a more detailed representation of the integrated circuit design (e.g., with the placements of the cells and wires in the overall floorplan of the design). Verification may then be applied to the integrated circuit design to detect potential violations of timing constraints. If any of these timing constraints is violated, an engineer modifies the design that was input to the placement and routing stage to resolve the violation and re-runs the placement and routing stage to generate a new placements and routing. However, these updated results may also exhibit timing violations (e.g., different timing violations). Accordingly, an engineer may iteratively modify the design until no violations are reported by the verification of the detailed design produced by the placement and routing stage. Each run of a stage of the integrated circuit design process may take, for example, tens to hundreds of hours of computing time, depending on the size of the integrated circuit design. In some circumstances, violations may be detected only through simulation or emulation of the integrated circuit design, which may further lengthen the feedback loop when iteratively developing an integrated circuit design.

Specifying timing constraints in a machine-readable format improves the performance of the placement and routing of cells as well as other stages in the process for designing integrated circuits, because those processing stages can use the timing constraint information in evaluating different options for generating the additional detail of the integrated circuit design. This in turn, improves the performance of the resulting implementations of the integrated circuit design, whether in an emulation system, in a fabricated prototype of the integrated circuit design, or in a manufactured integrated circuit product. However, as noted above specifying these timing constraints can be very difficult and time consuming, especially in the case of circuit elements that generate derived clock signals that may interact with one another.

Aspects of embodiments of the present disclosure relate to a system and method to automatically determine the clock constraints or timing constraints of an integrated circuit design and to annotate such a design with these determined clock constraints or timing constraints. The annotated integrated circuit design can then be provided to other stages of the integrated circuit design process, such as for performing static timing analysis (which allows detection of timing violations earlier in the integrated circuit design process and without performing simulation or emulation of the integrated circuit design) and for accounting for timing constraints during placement and routing (e.g., automatically computing the timings associated with different placement options and automatically accepting or rejecting placement options based on passing or failing associated timing constraints).

Some aspects of embodiments of the present disclosure relate to generating a hierarchy of clock signals, based on identifying a root clock and determining the derived clocks that are generated, directly or indirectly, by circuit elements (e.g., clock dividers) in the integrated circuit design. For example, a root clock may be a signal supplied from a clock source (e.g., a crystal oscillator), and the root clock may be supplied to control various circuit elements. The root clock may also be supplied to one or more clock dividers, which generate corresponding first derived clock signals. These first derived clock signals may be supplied to control various other circuit elements and may also be supplied to other clock dividers, which generate corresponding second derived clock signals. Therefore, the different derived clocks signals can be organized into a hierarchy where each derived clock signal is derived from a parent clock signal, where the parent clock signal may be a derived clock signal or the root clock signal. These derived clock signals are then applied to the circuit design in a machine-readable format, such as by setting timing constraints on the circuit elements based on these clock signals.

Technical advantages of the present disclosure include, but are not limited to, automatically determining clock constraints that are applicable to various portions of the integrated circuit design. Clock constraints determined based on embodiments of the present disclosure can then be used to improve various stages of the integrated circuit design process. For example, clock constraints allow static timing analysis to be performed (e.g., where static timing analysis would not be possible without the clock constraints generated by embodiments of the present disclosure), which allows potential violations of timing constraints to be detected early or during the running of the stage of the circuit design process (e.g., during a run of the placement and routing stage). In contrast, in circumstances where clock constraints for various portions of the integrated circuit design were not generated in accordance with embodiments of the present disclosure, then timing violations would be detected in the integrated circuit design only when performing a verification of the output of the stage of the integrated design process.

Improving the performance of a given stage of the integrated design process improves the quality of the resulting integrated circuit design. For example, earlier detection of potential timing violations allows those timing violations to be corrected earlier on, thereby shortening the time to generate a design that satisfies the design constraints. This reduced time shortens the development time (e.g., shortens the time to market) and/or allows more time in the budget to search for improved designs that provide higher performance (e.g., faster and/or more robust integrated circuit designs). Some stages of the integrated circuit design process may also take the determined clock constraints into account when generating the more detailed representation of the integrated circuit design.

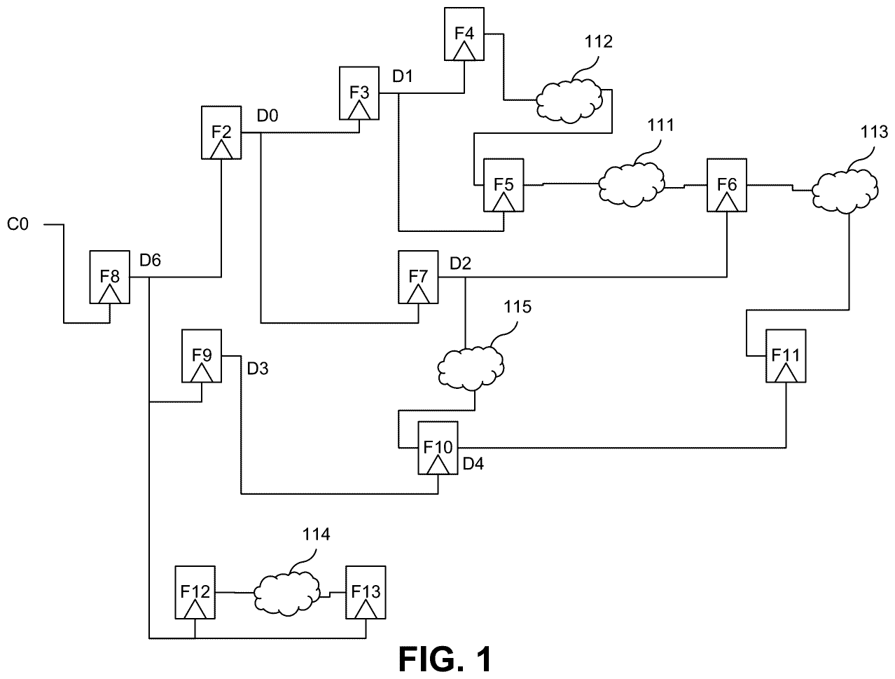

FIG. 1 is an example of an integrated circuit design having a root clock or user clock C0 and multiple derived clocks (e.g., labeled D0 through D6) at the outputs of various respective flip-flops (e.g., labeled F2 through F13) operating as clock dividers to which embodiments of the present disclosure may be applied to compute timing constraints. The integrated circuit design includes multiple networks (e.g., labeled 111 through 115) of circuit elements (e.g., combinational cells and sequential cells) that are driven or clocked by various ones of the derived clocks.

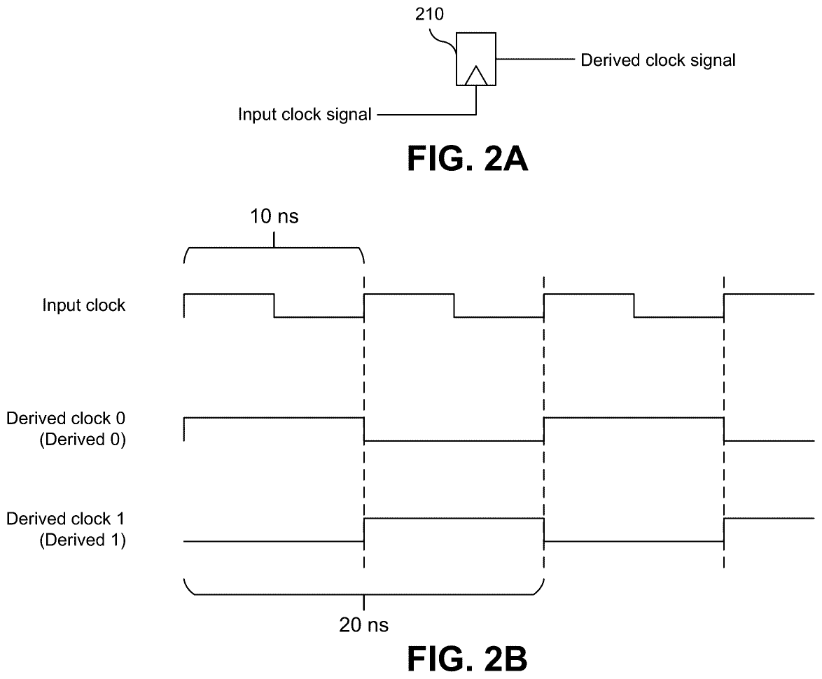

FIG. 2A shows a clock divider and a relationship between an input clock and an output derived clock. FIG. 2B illustrates possible derived clocks that may be output by a D flip-flop operating as a clock divider that is driven by an input clock signal at its rising edge. (A flip-flop operates as a clock divider when it is controlled by a clock signal.) As shown in FIG. 2A, the clock pin (or enable pin) of a flip-flop 210 operating as a clock divider is driven by an input clock signal (either a user clock such as root clock C0 or a derived clock) and outputs a derived clock signal. Assuming the case of a flip-flop triggered by the rising edge of its input clock signal, the output derived clock signal of the clock divider will have half the frequency of its input clock signal, in other words, twice the period of the input clock signal. For example, FIG. 2 further shows waveform diagrams including an input clock signal having a period of 10 nanoseconds and an output derived clock having a period of 20 ns.

As shown in FIG. 2B, there are two possible derived output clocks from the clock divider, depending on the initial state (or D value) of the D flip-flop of the clock divider. In a case where the flip-flop initially had a state that output a logic 0 (or logical low), the rising edge of the input clock causes the flip-flop to change its state to output a logic 1 (or logical high), as shown in the waveform labeled derived clock 0 (Derived0). On the other hand, in a case where the flip-flop initially had a state that output a logic 1 (or logical high), the rising edge of the input clock causes the flip-flop to change its state to output a logic 0 (or logical low), as shown in the waveform labeled derived clock 1 (Derived1). It is difficult or impossible to determine which of the two possible output derived clocks will be produced by a clock divider without additional information (e.g., information provided by the user as part of the integrated circuit design specifying the initial state of the flip-flop).

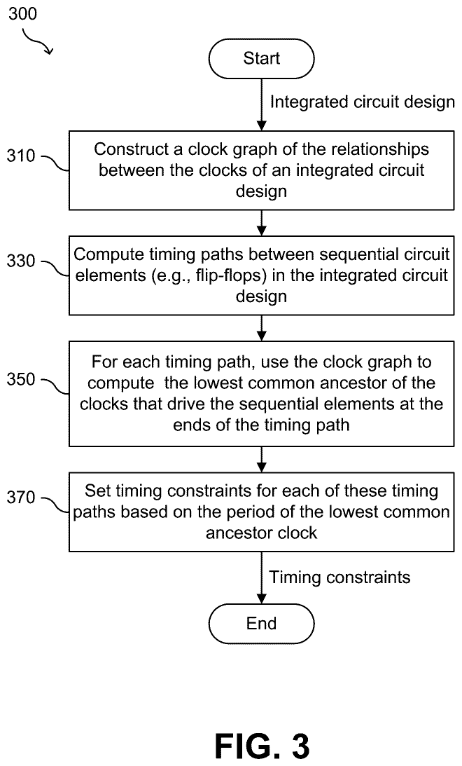

FIG. 3 is a flowchart illustrating a method 300 for automatically determining timing constraints according to one embodiment of the present disclosure. As shown in FIG. 3, the method takes in an input integrated circuit design (e.g., represented by a netlist including circuit elements including combinational circuit elements and sequential circuit elements) and begins, at 310, by constructing a clock graph of the relationships between the clocks of an integrated circuit design.

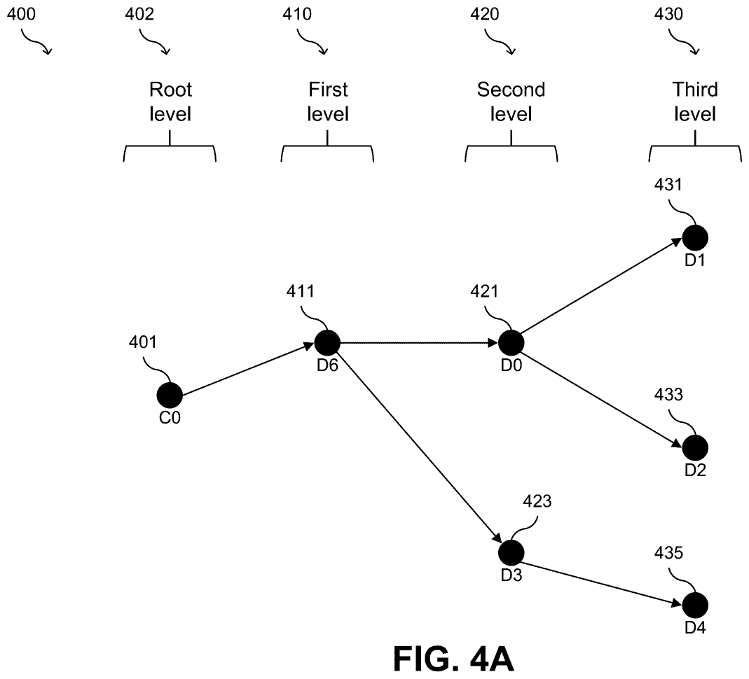

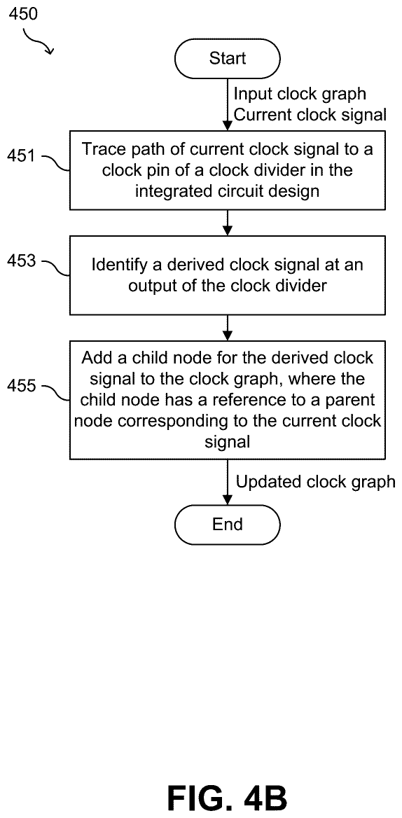

FIG. 4A is an example of a clock graph 400 depicting the relationships between the derived clocks D0 through D6 and the user clock C0 in the example integrated circuit design shown in FIG. 1, where a direct child derived clock has half the frequency of its immediate parent clock. As shown in FIG. 1, assuming that there is only one user clock C0, the frequencies of each of the derived clocks is derived from another clock in accordance with: D6←C0/2, D0←D6/2, D1←D0/2, D2←D0/2, D3←D6/2, D4←D3/2. Accordingly, the derived clocks can be organized into different levels of a clock graph 400 in accordance with the number of flip-flops or clock dividers between the derived clock and the root clock.

FIG. 4B is a flowchart depicting a method 450 for adding a node to a clock graph according to one embodiment of the present disclosure. The method 450 takes, as input, an input clock graph and a current clock signal to be considered. The input clock graph may be initialized by creating a root node for the user clock signal (or, in the case of multiple user clocks, multiple root nodes where each root node corresponds to a different user clock). The current clock signal to be considered is a clock signal that is already represented in the clock graph (e.g., initially, one of the user clocks).

At 451, the processor traces a path of the current clock signal through the integrated circuit design until the clock signal reaches a clock pin of a clock divider (e.g., a clock pin of a flip-flop) that is configured to output a derived clock based on an input clock (see, e.g., FIG. 2B). At 453, the processor determines a derived clock signal at the output of that clock divider.

FIG. 1 shows a root clock C0 that is supplied to the clock pin of flip-flop F8 operating as a clock divider. The root clock C0 is represented in the graph of FIG. 4A as node 401 in root level 402 of the clock graph 400. The flip-flop F8 generates derived clock D6 at its output, where the derived clock D6 has half the frequency (or twice the period) of root clock C0. (The processor determines that an output is a derived clock signal if that output is connected to a clock pin of a flip-flop.) At 455, the processor adds a child node for the derived clock signal to the clock graph, where the child node has a reference to a parent node corresponding to the current clock signal (in FIG. 4A, the reference to the parent node is indicated by the edge or line from a child node to its parent node), which results in an updated clock graph. The derived clock D6 is represented by node 411 in the first level 410 of the clock graph 400.

The current clock signal is traced to each clock divider that it is directly connected to, thereby adding a new node for each clock signal derived from that current clock signal. In addition, the method shown in FIG. 4B is performed for every clock signal, including derived clock signals that are determined through this process. The clock signals may be processed, for example, in a depth-first order or a breadth-first order and may be distributed across multiple processing threads executed on one or more processors to generate an updated clock graph for the clocks of the integrated circuit design.

The output of flip-flop F8 supplies derived clock D6 to the clock pins of flip-flop F2, flip-flop F9, flip-flop F12, and flip-flop F13. As noted above, in circumstances where the initial state of the flip-flop F8 is unspecified, it is difficult or impossible to determine the phase of the output derived clock D6 (e.g., whether the phase of output derived clock D6 will correspond to derived clock 0 or derived clock 1 as shown in FIG. 2B). This, in turn, results in ambiguity regarding the phase of the derived clock signal supplied to the clock pins (or enable pins) of flip-flop F2, flip-flop F9, flip-flop F12, and flip-flop F13.

Flip-flop F2 produces a derived clock DO at its output pin, where the derived clock DO has half the frequency of the derived clock D6 that was supplied as input to flip-flop F2. Derived clock DO has a frequency that is half the frequency of its immediate parent derived clock D6 (and therefore has one-quarter the frequency, or four times the period, of user clock C0). Derived clock DO is represented by node 421 in the second level 420 of the clock graph 400, where node 421 for derived clock DO is a direct child of parent node 411 for derived clock D6 in the first level 410 (first level 410 are the direct children of root clock C0 represented by node 401 in the root level 402). As noted above, in some embodiments, the method 450 shown in FIG. 4B is applied to trace the derived clock D6 to flip-flop F2 and to generate the node 421 for derived clock DO and add that node as a child of node 411 corresponding to its parent clock, derived clock D6. Similarly, flip-flop F9 produces derived clock D3 at its output pin, where the derived clock D3 has half the frequency of the derived clock D6 that was supplied as input to flip-flop F9. Accordingly, derived clock D3 is represented by node 423 in the second level 420 of the clock graph 400, where node 423 for derived clock D3 is a direct child of parent node 411 for derived clock D6 in the first level 410.

The output of flip-flop F2 is connected to the clock pin of flip-flop F3 and the clock pin of flip-flop F7. Flip-flop F3 generates a derived clock D1 (represented in FIG. 4A as node 431 in the third level 430 of the clock graph 400) and flip-flop F7 generates a derived clock D2 (represented in FIG. 4A as node 433 in the third level 430 of the hierarchy).

Similarly, the output of flip-flop F9 is connected to the clock pin of flip-flop F10. Flip-flop F10 produces a derived clock D4, which is supplied to the clock pin of flip-flop F11. Derived clock D4 is represented in the clock graph 400 as third level 430 node 435.

While FIG. 1 and FIG. 4A show an example of a case where there is only one user clock C0, embodiments of the present disclosure are not limited thereto and include embodiments where there are multiple user clocks. In some such embodiments, the clock graph may be represented as a forest of multiple clock trees (e.g., multiple different user clocks), where each clock tree in the forest has a different user clock at its root and the derived clocks that are generated based on that corresponding user clock.

At 330, the processor computes timing paths between sequential circuit elements (e.g., flip-flops) in the integrated circuit design, where the timing path between these sequential circuit elements includes one or more combinational elements (e.g., stateless circuit elements such as logic gates). In one embodiment, the timing path does not include sequential elements (e.g., storage elements such as flip-flops, latches, and/or registers) apart from the sequential elements at the launch and capture ends of the timing path.

FIG. 1 illustrates various timing paths (e.g., combinational networks) between flip-flops (e.g., sequential elements). As mentioned above, a first combinational network 111 forms a timing path from a launch end of the path at flip-flop F5 to a capture end of the path at flip-flop F6. A second combinational network 112 forms a timing path from a launch end of the path at flip-flop F4 to a capture end of the path at flip-flop F5. A third combinational network 113 forms a timing path from a launch end of the path at flip-flop F6 to a capture end of the path at flip-flop F11. A fourth combinational network 114 forms a timing path from a launch end of the path at flip-flop F12 to a capture end of the path at flip-flop F13. A fifth combinational network 115 forms a timing path from a launch end of the path at flip-flop F7 to a capture end of the path at flip-flop F10.

Referring to FIG. 1, flip-flop F5 is driven by clock D1 and flip-flop F6 is driven by clock D2. Both derived clock D1 and derived clock D2 are three clock dividers away from the user clock C0 and therefore operate at one eighth the frequency of the user clock C0, therefore suggesting that there are 8 cycles of user clock C0 (e.g., a clock distance of 80 ns, assuming the root clock C0 has a period of 10 ns) between flip-flop F5 and flip-flop F6. This suggests that a signal propagating through a combinational network 111 from F5 to F6 has 80 ns of time to arrive before flip-flop F6 samples its input.

However, as noted above, any given clock divider may have two different possible output waveforms with different phases. Therefore, it is possible that derived clock D1 and derived clock D2 have the same period but different phases, in which case there is only half as much time (40 ns) between the rising edge of derived clock D1 at flip-flop F5 and the next rising edge of derived clock D2 at flip-flop F6.

In contrast, flip-flop F4 and flip-flop F5 are both driven by the same clock: derived clock D1. Therefore, there are expected to be 8 cycles of user clock C0 between flip-flop F4 and flip-flop F5 (e.g., there is no concern regarding the flip-flops at the launch and capture ends being driven by clocks having different phases). Similarly, flip-flop F12 and flip-flop F13 are both driven by same derived clock D6 and therefore there are expected to be 2 cycles of user clock C0 between flip-flop F12 and flip-flop F13.

As seen in FIG. 1, flip-flop F6 and flip-flop F11 at the launch and capture ends of the path through combinational network 113 are driven by derived clock D2 and derived clock D4, respectively. Likewise, flip-flop F7 and flip-flop F110 at the launch and capture ends of the path through combinational network 115 are driven by derived clock D0 and derived clock D3, respectively. The relationships between derived clock D2 and derived clock D4 for combinational network 113 and the relationship between derived clock D0 and derived clock D3 for combinational network 115 are more complex than the examples given above.

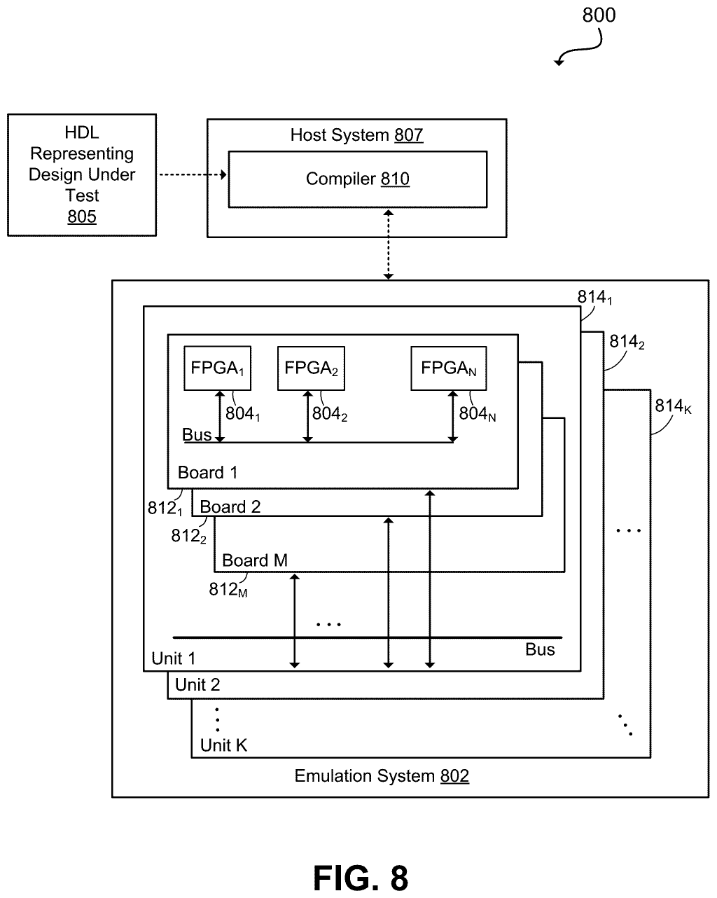

Accordingly, aspects of embodiments of the present disclosure relate to computing these additional timing constraints along timing paths between flip-flops (or other sequential elements) within the integrated circuit design and providing such timing constraints for use in later stages of the integrated circuit design process (e.g., for configuring FPGAs of an integrated circuit emulation system, see, e.g., FIG. 8 described below).

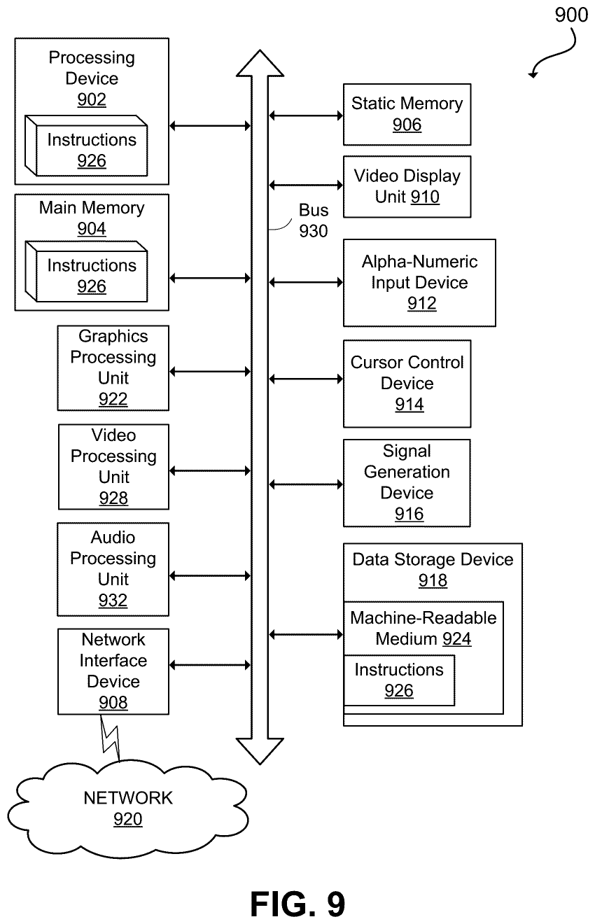

In more detail, some aspects of embodiments of the present disclosure relate to computing (using a processing device such as a computer system including a processor and memory, such as the computer system shown in FIG. 9) clock distances between the pair of flip-flops at launch and capture ends of a timing path by tracing the pair of clocks to their lowest common ancestor (LCA) in the clock graph and using the period of the LCA as the clock distance between those two flip-flops.

At 350, the processor uses the clock graph to trace the lowest common ancestor clock of the clocks that drive the sequential elements at the launch and capture ends of each timing path. The lowest common ancestor clock refers to the closest common clock that is associated with driving the clocks that clock the sequential elements at the launch path and the capture path of the timing path.

Table 1, below, shows the various paths through the combinational networks, the corresponding clock paths, the lowest common ancestors of those clock paths based on the clock graph shown in FIG. 4A, and the clock distance based on the period of the lowest common ancestor.

TABLE 1

| | Clock | Lowest common | Clock |
|---|---|---|---|
| Timing Paths | Paths | ancestor | Distance) |
| F12 [symbol] F13 | D6 → D6 | D6 | 1 cycle |
| F7 [symbol] F10 | D0 → D3 | D6 | 1 cycle |
| F4 [symbol] F5 | D1 → D1 | D1 | 4 cycles |
| F5 [symbol] F6 | D1 → D2 | D0 | 2 cycles |
| F6 [symbol] F11 | D2 → D4 | D6 | 1 cycle |

In the above table the timing path of flip-flop F12→flip-flop F13 corresponds to the timing path through combinational network 114 shown in FIG. 1. As seen in FIG. 1, flip-flop F12 and flip-flop F13 are both controlled by derived clock signal D6, so the clock path is D6→D6. These are the same clock signal, so the lowest common ancestor is derived clock signal D6 itself. Referring to the clock graph shown in FIG. 4A, derived clock signal D6 is a first level clock signal and therefore its period is twice the period of the user clock signal. In table 4, it is assumed that the period of the user clock signal is 10 ns, and therefore the clock distance for the timing path flip-flop F12→flip-flop F13 is one clock cycle of D6, which is 20 ns.

Similarly, the timing path of flip-flop F4→flip-flop F5 corresponds to the timing path through combinational network 112 shown in FIG. 1. Both flip-flop F4 and flip-flop F5 are controlled by derived clock signal D1, and therefore their lowest common ancestor is derived clock signal D1 itself. Hence, the clock distance is the period of derived clock signal D1. As shown in the clock graph 400 of FIG. 4A, derived clock signal D1 is a third level signal and so its period is 8 times the period of the user clock (in this example, 8 times 10 ns is 80 ns).

As another example, the timing path of flip-flop F7→flip-flop F10 corresponds to the timing path through combinational network 115 shown in FIG. 1. Flip-flop F7 is controlled by derived clock signal DO and flip-flop F10 is controlled by derived clock signal D3. Referring to the clock graph 400 of FIG. 4A, the lowest common ancestor node to derived clock signal DO at node 421 and derived clock signal D3 at node 423 is derived clock signal D6 at node 411. Because derived clock signal DO and derived clock signal D3 were derived using different flip-flops, they may have different phases, as shown in FIG. 2B (depending on the initial states of flip-flop F2 and flip-flop F9, respectively). Accordingly, to ensure there is no timing violation along the timing path through combinational network 115, it is assumed that derived clock signal DO and derived clock signal D3 have different phases and the clock distance between them is the period of their lowest common ancestor clock signal: derived clock signal D6, which has a period of 20 ns.

Similarly, the timing path of flip-flop F5→flip-flop F6 through combinational network 111 shown in FIG. 1 can be analyzed in a similar manner. Flip-flop F5 is controlled by derived clock signal D1 and flip-flop F6 is controlled by derived clock signal D2. The lowest common ancestor clock signal to these derived clock signals is clock signal DO, which has a period of 40 ns. Therefore, the clock distance between flip-flop F5 and flip-flop F6 is 40 ns.

The timing path of flip-flop F6→flip-flop F11 can also be analyzed in a similar manner. Flip-flop F6 is controlled by derived clock signal D2 and flip-flop F11 is controlled by derived clock signal D4. The clock graph 400 shown in FIG. 4A shows that the lowest common ancestor of derived clock signal D2 at node 433 and derived clock signal D4 at node 435 is derived clock signal D6 at node 411. Derived clock signal D6 has a period of 20 ns and therefore the clock distance between flip-flop F6 and flip-flop F11 is 20 ns.

At 370, the processor sets timing constraints for each of these timing paths based on the period of the corresponding lowest common ancestor clock.

Table 2, below, illustrates the timing constraints or clock constraints that are to be set on the integrated circuit design based on the presence of timing paths between flip-flops. In this table, the value in a cell represents a clock distance (in the number of cycles of the user clock C0) from the clock in the corresponding row of the table to the clock in the corresponding column of the table. For example, the timing path from flip-flop F6 to flip-flop F11 through combinational network 113 corresponds to a clock path from D2 to D4, and the cell at row D2 and column D4 has a value of 2, corresponding to the clock distance of 20 ns shown in Table 1. Only the cells that correspond to timing paths between flip-flops are filled-in as constraints that are to be set and the remaining cells of Table 2 remain blank (n/a) because no constraint needs to be set based on those clocks (due to a lack of timing paths between flip-flops driven by those clocks).

TABLE 2

| | D0 | D1 | D2 | D3 | D4 | D6 | C0 |
|---|---|---|---|---|---|---|---|
| D0 | n/a | n/a | n/a | 2 | n/a | n/a | n/a |
| D1 | n/a | 8 | 4 | n/a | n/a | n/a | n/a |
| D2 | n/a | n/a | n/a | n/a | 2 | n/a | n/a |
| D3 | n/a | n/a | n/a | n/a | n/a | n/a | n/a |
| D4 | n/a | n/a | n/a | n/a | n/a | n/a | n/a |
| D6 | n/a | n/a | n/a | n/a | n/a | 2 | n/a |
| C0 | n/a | n/a | n/a | n/a | n/a | n/a | n/a |

These timing constraints are then set as machine-readable instructions or machine-readable representations in the machine-readable representation of the integrated circuit design. Some aspects of embodiments of the present disclosure relate to non-limiting examples of techniques for representing these automatically detected timing constraints.

In some embodiments, the machine-readable representation of the timing constraints is set based on defining multicycle paths (MCPs). This approach may be applicable in cases where the downstream consumer of the machine-readable representation of the timing constraints (e.g., an emulation compiler) does not support setting constraints based on a maximum path delay (sometimes referred to as set_max_delay).

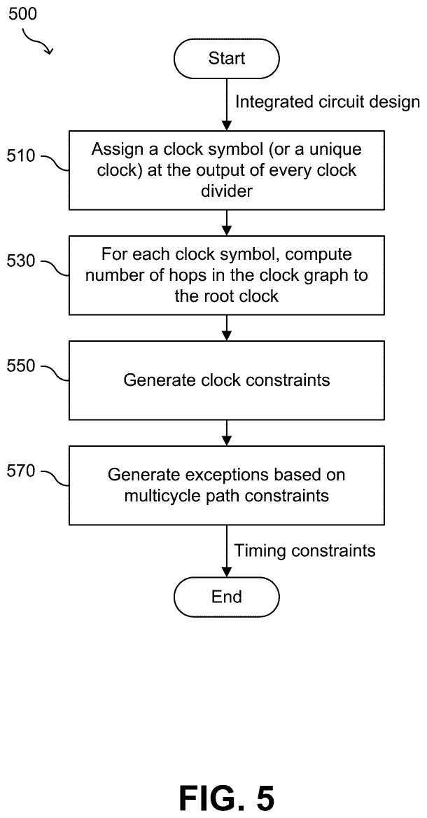

FIG. 5 is a flowchart depicting a method 500 for setting timing constraints using multicycle path constraints according to one embodiment of the present disclosure. At 510, the processor assigns a clock symbol (or a unique clock) at the output of every clock divider. At 530, the processor, for each clock symbol, computes the number of hops in the clock graph to the root clock. For example, for derived clock DO, there are two hops to root clock C0 (the first hop to derived clock D6 and the second hop is from D6 to C0).

At 550, the processor generates clock constraints for each of the generated clocks. In this embodiment, the generated clocks are set to have the same period as their parent clock. Continuing the example above with respect to FIG. 1, the clock constraints may be generated as shown in Table 3, below:

TABLE 3

| | | | | | |
|---|---|---|---|---|---|
| create_generated_clock -name | { D6 } | -master | C0 | -divide_by | 1 |
| create_generated_clock -name | { D0 } | -master | D6 | -divide_by | 1 |
| create_generated_clock -name | { D1 } | -master | D0 | -divide_by | 1 |
| create_generated_clock -name | { D2 } | -master | D0 | -divide_by | 1 |
| create_generated_clock -name | { D3 } | -master | D6 | -divide_by | 1 |
| create_generated_clock -name | { D4 } | -master | D3 | -divide_by | 1 |

At 570, additional design constraints are set by generating exceptions based on multicycle path constraints, e.g., setting multicycle paths between the clocks, as shown in Table 4, below:

TABLE 4

| | | | | |
|---|---|---|---|---|
| set_multicycle_path -from | {c: D1} | -to | {c: D1} | { 8 } |
| set_multicycle_path -from | {c: D1} | -to | {c: D2} | { 4 } |
| set_multicycle_path -from | {c: D2} | -to | {c: D4} | { 2 } |
| set_multicycle_path -from | {c: D0} | -to | {c: D3} | { 2 } |
| set_multicycle_path -from | {c: D6} | -to | {c: D6} | { 2 } |

Accordingly, this generates a machine-readable set of constraints representing the detected timing constraints.

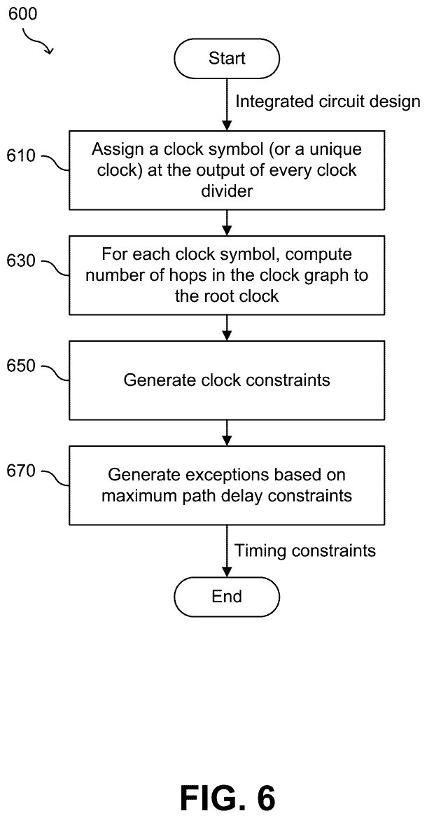

FIG. 6 is a flowchart depicting a method 600 for setting timing constraints using maximum path delay constraints according to one embodiment of the present disclosure. At 610, the processor assigns a clock symbol (or a unique clock) at the output of every clock divider. At 630, the processor, for each clock symbol, computes the number of hops in the clock graph to the root clock.

At 650, the processor generates clock constraints for each of the derived clocks. In this embodiment, the clocks are generated with periods that are set based on their parent clocks (e.g., half the frequency of the parent clock), as shown in Table 5, below:

TABLE 5

| | | | | | | |
|---|---|---|---|---|---|---|
| create_generated_clock | -name | { D0 } | -master | D6 | -divide_by | 2 |
| create_generated_clock | -name | { D1 } | -master | D0 | -divide_by | 2 |
| create_generated_clock | -name | { D2 } | -master | D0 | -divide_by | 2 |
| create_generated_clock | -name | { D3 } | -master | D6 | -divide_by | 2 |
| create_generated_clock | -name | { D4 } | -master | D3 | -divide_by | 2 |

At 670, additional design constraints are set by generating exceptions based on maximum path delay constraints, as shown in Table 6, below:

TABLE 6

| | | | | | |
|---|---|---|---|---|---|
| set_max_delay | -from | {c: D0} | -to | {c: D3} | {20} |
| set_max_delay | -from | {c: D1} | -to | {c: D2} | {40} |
| set_max_delay | -from | {c: D2} | -to | {c: D4} | {20} |

Note that in the second approach shown in FIG. 6, only three constraints were set, corresponding to the timing paths where the flip-flops were controlled by different clocks (e.g., D0→D3), whereas in the first approach shown in FIG. 5, a constraint was set for each timing path, including where the flip-flops at each end were driven by the same clock (e.g., D1→D1).

More precisely, the number of constraints that will be created in taking the two approaches discussed above is as follows. Defining variables as follows:
Total number of derived clocks: n
Total number of user generated clocks (e.g., user specified clocks that are derived from other clocks, such that there is no ambiguity in the phase of the clock): m
Total number of user created clocks: k
Total number of clocks N=n+m+k

Then Table 7 Mᵢⱼ of the relationships between the clocks can be constructed similar to that of Table 2, showing the number of clock cycles (e.g., of a root clock) between two clocks in the design. Cells with the value n/a indicate that there is no timing path in the integrated circuit design between those clocks.

TABLE 7

| | D0 | D1 | . . . | Dn | CGC0 | . . . | CGCm | C0 | . . . | Ck |
|---|---|---|---|---|---|---|---|---|---|---|
| D0 | 2 | n/a | . . . | . . . | . . . | . . . | . . . | . . . | . . . | . . . |
| D1 | n/a | 4 | . . . | . . . | . . . | . . . | . . . | . . . | . . . | . . . |
| . . . | . . . | . . . | . . . | . . . | . . . | . . . | . . . | . . . | . . . | . . . |
| Dn | . . . | 2 | . . . | . . . | . . . | . . . | . . . | . . . | . . . | . . . |
| CGC0 | . . . | . . . | . . . | . . . | . . . | . . . | . . . | . . . | . . . | . . . |
| . . . | . . . | . . . | . . . | . . . | . . . | . . . | . . . | . . . | . . . | . . . |
| CGCm | . . . | . . . | . . . | . . . | . . . | . . . | . . . | . . . | . . . | . . . |
| C0 | . . . | . . . | . . . | . . . | . . . | . . . | . . . | . . . | . . . | . . . |
| . . . | . . . | . . . | . . . | . . . | . . . | . . . | . . . | . . . | . . . | . . . |
| Ck | . . . | . . . | . . . | . . . | . . . | . . . | . . . | . . . | . . . | . . . |

Table 8 TH, below, can be constructed from Table 7 My, above, by filling in a 1 where a timing path exists in the integrated circuit design between a pair of clocks and filling in a 0 where no path exists between that pair of clocks:

TABLE 8

| | D0 | D1 | . . . | Dn | CGC0 | . . . | CGCm | C0 | . . . | Ck |
|---|---|---|---|---|---|---|---|---|---|---|
| D0 | 1 | 0 | . . . | . . . | . . . | . . . | . . . | . . . | . . . | . . . |
| D1 | 0 | 1 | . . . | . . . | . . . | . . . | . . . | . . . | . . . | . . . |
| . . . | . . . | . . . | . . . | . . . | . . . | . . . | . . . | . . . | . . . | . . . |
| Dn | . . . | . . . | . . . | . . . | . . . | . . . | . . . | . . . | . . . | . . . |
| CGC0 | . . . | . . . | . . . | . . . | . . . | . . . | . . . | . . . | . . . | . . . |
| . . . | . . . | . . . | . . . | . . . | . . . | . . . | . . . | . . . | . . . | . . . |
| CGCm | . . . | . . . | . . . | . . . | . . . | . . . | . . . | . . . | . . . | . . . |
| C0 | . . . | . . . | . . . | . . . | . . . | . . . | . . . | . . . | . . . | . . . |
| . . . | . . . | . . . | . . . | . . . | . . . | . . . | . . . | . . . | . . . | . . . |
| Ck | . . . | . . . | . . . | . . . | . . . | . . . | . . . | . . . | . . . | . . . |

Based on the above, the total number of exceptions that are created under the first approach shown in FIG. 5 using MCP exceptions is:

$${\sum }_{i = 0}^{n} {\sum }_{j = 0}^{n} {T}_{i , j}$$

Such that the exceptions are limited to the paths in the n×n region in the upper left of Table 8 Tᵢⱼ. The source and the sink of the paths along with the clock distances for constructing the multicycle path exceptions can be found from Table 7 Mᵢⱼ.

On the other hand, the total number of exceptions that are created under the second approach shown in FIG. 6 using maximum path delay exceptions is:

$${\sum }_{i = 0}^{N} {\sum }_{j = 0}^{N} {T}_{i , j} , if i > n then j \leq n , if j > n then i \leq n , i \neq j$$

Such that the exceptions are limited to the paths in the n×n dark shaded region in the upper left of Table 8 Tᵢⱼ, plus the n×(m+k) and (m+k)×n lightly shaded regions in the upper right and lower left portions of Table 8 Tᵢⱼ. The source and the sink of the paths along with the clock distances for constructing the maximum path delay exceptions can be found from Table 7 Mᵢⱼ.

Accordingly, aspects of embodiments of the present disclosure relate to automatically determining timing constraints in an integrated circuit design and automatically generating machine-readable representations of the timing constraints, such as by generating multicycle path constraints or maximum path delay constraints. In more detail, clock dividers in an integrated circuit design generate new clock signals, where a new clock has half the frequency (twice the period) of its parent clock. Paths from flip-flops driven by different clocks are not guaranteed to have the full clock cycle given an ambiguity in the initial state of the flip-flop, thereby resulting in ambiguity in the phase of the derived clock. To account for this ambiguity, embodiments of the present disclosure trace the different clocks to their least common ancestor and use the period of that least common ancestor as a conservative constraint on the clock distance between the clocks (e.g., conservative in that the estimate may be tighter constraint than necessary, depending on the initial states of the associated driven flip-flops). These computed constraints are then annotated as machine-readable representations (e.g., MCP constraints or maximum path delay constraints) to be supplied to downstream stages in the process for designing an integrated circuit. These explicit timing constraints improve the runtimes of the downstream stages or improve the performance of resulting emulated integrated circuit designs or fabricated integrated circuit designs (e.g., by reducing the exploration that is performed when searching for placements that meet requirements or by relaxing overly conservative assumptions regarding timing constraints).

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 7. The processes described by FIG. 7 may be enabled by EDA products (or EDA systems).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

A storage subsystem of a computer system (such as computer system 900 of FIG. 9, or host system 807 of FIG. 8) may be used to store the programs and data structures that are used by some or all of the EDA products described herein, and products used for development of cells for the library and for physical and logical design that use the library.

FIG. 8 depicts a diagram of an example emulation environment 800. An emulation environment 800 may be configured to verify the functionality of the circuit design. The emulation environment 800 may include a host system 807 (e.g., a computer that is part of an EDA system) and an emulation system 802 (e.g., a set of programmable devices such as Field Programmable Gate Arrays (FPGAs) or processors). The host system generates data and information by using a compiler 810 to structure the emulation system to emulate a circuit design. A circuit design to be emulated is also referred to as a Design Under Test (‘DUT’) where data and information from the emulation are used to verify the functionality of the DUT.

The host system 807 may include one or more processors. In the embodiment where the host system includes multiple processors, the functions described herein as being performed by the host system can be distributed among the multiple processors. The host system 807 may include a compiler 810 to transform specifications written in a description language that represents a DUT and to produce data (e.g., binary data) and information that is used to structure the emulation system 802 to emulate the DUT. The compiler 810 can transform, change, restructure, add new functions to, and/or control the timing of the DUT.

The host system 807 and emulation system 802 exchange data and information using signals carried by an emulation connection. The connection can be, but is not limited to, one or more electrical cables such as cables with pin structures compatible with the Recommended Standard 232 (RS232), universal serial bus (USB), or Peripheral Component Interconnect Express (PCIe or PCI Express) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 807 and emulation system 802 can exchange data and information through a third device such as a network server.

The emulation system 802 includes multiple FPGAs (or other modules) such as FPGAs 804₁ and 804₂ as well as additional FPGAs to 804_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 802 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 804₁-804_{N} may be placed onto one or more boards 812₁ and 812₂ as well as additional boards through 812_{M}. Multiple boards can be placed into an emulation unit 814₁. The boards within an emulation unit can be connected using the backplane of the emulation unit or any other types of connections. In addition, multiple emulation units (e.g., 814₁ and 814₂ through 814_{K}) can be connected to each other by cables or any other means to form a multi-emulation unit system.

For a DUT that is to be emulated, the host system 807 transmits one or more bit files to the emulation system 802. The bit files may specify a description of the DUT and may further specify partitions of the DUT created by the host system 807 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 807 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 807 and/or the compiler 810 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 805 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 9 illustrates an example machine of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM), a static memory 906 (e.g., flash memory, static random access memory (SRAM), etc.), and a data storage device 918, which communicate with each other via a bus 930.

Processing device 902 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 may be configured to execute instructions 926 for performing the operations and steps described herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a non-transitory computer-readable medium) on which is stored one or more sets of instructions 926 or software embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

In some implementations, the instructions 926 include instructions to implement functionality corresponding to the present disclosure. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 902 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving an integrated circuit design;
obtaining a timing path between a first sequential circuit element at a launch end of the timing path and a second sequential circuit element at a capture end of the timing path of the integrated circuit design;
determining, by a processing device, a common clock that drives a first clock clocking the first sequential circuit element and a second clock clocking the second sequential circuit element based on a clock graph of relationships between a plurality of clocks of the integrated circuit design; and
setting a timing constraint for the timing path of the integrated circuit design based on a period of the common clock.

2. The method of claim 1, wherein the timing constraint is a maximum path delay constraint.

3. The method of claim 1, wherein the timing constraint is a multicycle path constraint.

4. The method of claim 1, wherein the integrated circuit design comprises a clock divider, and
wherein the plurality of clocks of the integrated circuit design comprises:
an input clock supplied to the clock divider; and
a derived clock output by the clock divider, the derived clock having a derived clock period twice as long as an input clock period of the input clock.

5. The method of claim 1, further comprising constructing the clock graph, the constructing the clock graph comprising:
adding a first root node of the clock graph corresponding to a first user clock of the plurality of clocks;
tracing the first user clock to a first clock divider of the integrated circuit design;
identifying a first derived clock at a first output of the first clock divider; and
adding a first child node corresponding to the first derived clock as a child of the first root node in the clock graph.

6. The method of claim 5, further comprising:
tracing the first derived clock to a second clock divider;
identifying a second derived clock at a second output of the second clock divider; and
adding a second child node corresponding to the second derived clock as a child of the first child node in the clock graph.

7. The method of claim 5, further comprising:
adding a second root node of the clock graph corresponding to a second user clock;
tracing the second user clock to a third clock divider of the integrated circuit design;
identifying a third derived clock at a third output of the third clock divider; and
adding a third child node corresponding to the third derived clock as a child of the second root node in the clock graph.

8. A system comprising:
a memory storing instructions; and
a processor, coupled with the memory and to execute the instructions, the instructions when executed cause the processor to:
receive an integrated circuit design;
compute a timing path between a first sequential circuit element at launch end of the timing path and a second sequential circuit element at a capture end of the timing path of the integrated circuit design;
compute, using a clock graph of relationships between a plurality of clocks of the integrated circuit design, a timing constraint on the timing path based on a first clock driving the first sequential circuit element and a second clock driving the second sequential circuit element;
output a machine-readable representation of the integrated circuit design, the machine-readable representation comprising a representation of the computed timing constraint of the timing path; and
perform a stage of an electronic design automation process on the machine-readable representation of the integrated circuit design based on the representation of the computed timing constraint of the timing path.

9. The system of claim 8, wherein the timing constraint is a maximum path delay constraint.

10. The system of claim 8, wherein the timing constraint is a multicycle path constraint.

11. The system of claim 8, wherein the stage of the electronic design automation process comprises static timing analysis based on the computed timing constraint.

12. The system of claim 8, wherein the stage of the electronic design automation process comprises placement and routing of cells of the integrated circuit design based on the computed timing constraint.

13. The system of claim 8, wherein the stage of the electronic design automation process comprises generating a representation of the integrated circuit design to configure an emulation system comprising one or more field programmable gate arrays based on the computed timing constraint.

14. The system of claim 8, wherein the memory further stores instructions, which when executed by the processor, cause the processor to:
add a first root node of the clock graph corresponding to a first user clock;
trace the first user clock to a first clock divider of the integrated circuit design;
identify a first derived clock at an output of the first clock divider; and
add a first child node corresponding to the first derived clock as a child of the first root node in the clock graph.

15. A non-transitory computer-readable medium comprising stored instructions, which when executed by a processor, cause the processor to:
receive an integrated circuit design;
obtain a timing path between a first sequential circuit element at launch end of the timing path and a second sequential circuit element at a capture end of the timing path of the integrated circuit design;
determine a common clock that drives a first clock clocking the first sequential circuit element and a second clock clocking the second sequential circuit element based on a clock graph of relationships between a plurality of clocks of the integrated circuit design;
set a timing constraint for the timing path of the integrated circuit design based on a period of the common clock; and
output a machine-readable representation of the integrated circuit design, the machine-readable representation comprising a representation of the timing constraint of the timing path.

16. The non-transitory computer-readable medium of claim 15, wherein the timing constraint is a maximum path delay constraint.

17. The non-transitory computer-readable medium of claim 15, wherein the timing constraint is a multicycle path constraint.

18. The non-transitory computer-readable medium of claim 15, wherein the integrated circuit design comprises a clock divider, and
wherein the plurality of clocks of the integrated circuit design comprises:
an input clock supplied to the clock divider; and
a derived clock output by the clock divider, the derived clock having a derived clock period that is twice as long as an input clock period of the input clock.

19. The non-transitory computer-readable medium of claim 15 further storing instructions, which when executed by the processor, cause the processor to:
add a first root node of the clock graph corresponding to a first user clock of the plurality of clocks;
trace the first user clock to a first clock divider of the integrated circuit design;
identify a first derived clock at a first output of the first clock divider; and
add a first child node corresponding to the first derived clock as a child of the first root node in the clock graph.

20. The non-transitory computer-readable medium of claim 19 further storing instructions, which when executed by the processor, cause the processor to:
trace the first derived clock to a second clock divider,
identify a second derived clock at a second output of the second clock divider; and
add a second child node corresponding to the second derived clock as a child of the first child node in the clock graph.
